(19) United States
(12) Patent Application Publication
(10) Pub. No.: US 2004/0225729 A1
(43) Pub. Date: Nov. 11, 2004

(54) Dynamic display of round-trip times of message sequences

(76) Inventors: Mark L. Sabiers, Fort Collins, CO (US); David Christopher Davidson, Windsor, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/434,639

(22) Filed: May 9, 2003

(51) Int. Cl. G06F 15/173

(52) U.S. Cl. 709/224

(57) ABSTRACT

Various systems, methods, and computer programs embodied in computer readable mediums are provided for displaying message timing. In one embodiment, a system for displaying message timing is provided that comprises a processor circuit having a processor and a memory, a display device operatively coupled to the processor circuit, and round-trip time display logic stored in the memory and executable by the processor. The round-trip time display logic comprises logic that displays a graphical representation of a round-trip message sequence between a first service and a second service on the display device, and logic that displays a message sequence time of the round-trip message sequence on the display device in association with the graphical representation of the round-trip message sequence.

### BACKGROUND

Various services made available on the Internet such as those made available by application service providers may incorporate several other services available on the Internet into their own service. For example, a service such as a web service that provides travel related information might incorporate or reference a separate map making service provided by a third party into their web service to supplement the content they offer to users. For such scenarios, the web service will communicate with other services on the Internet to obtain the desired content such as, for example, maps or other content. Unfortunately, the turnaround time between when a request for predefined content is transmitted to a particular service and when the reply with the content is received can vary widely, thereby affecting the responsiveness of the requesting service to users.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram that illustrates a web services network that facilitates the generation of round-trip message sequences between web services or other services and that facilitates the recording of round-trip times of the message sequences according to an embodiment of the present invention;

FIG. 2 is a drawing of a user interface generated by a message sequence display tool 156 executed within a message monitoring system within the web services network of FIG. 1 according to an embodiment of the present invention;

FIG. 3 is a flow chart of a portion of the message sequence display tool implemented in the message monitoring system of FIG. 1 to generate representations of message sequences on the user interface of FIG. 2 according to an embodiment of the present invention; and

FIG. 4 is a flow chart of round-trip time display logic implemented in the message monitoring system of FIG. 1 to generate round-trip times on the user interface of FIG. 2 according to an embodiment of the present invention.

### DETAILED DESCRIPTION

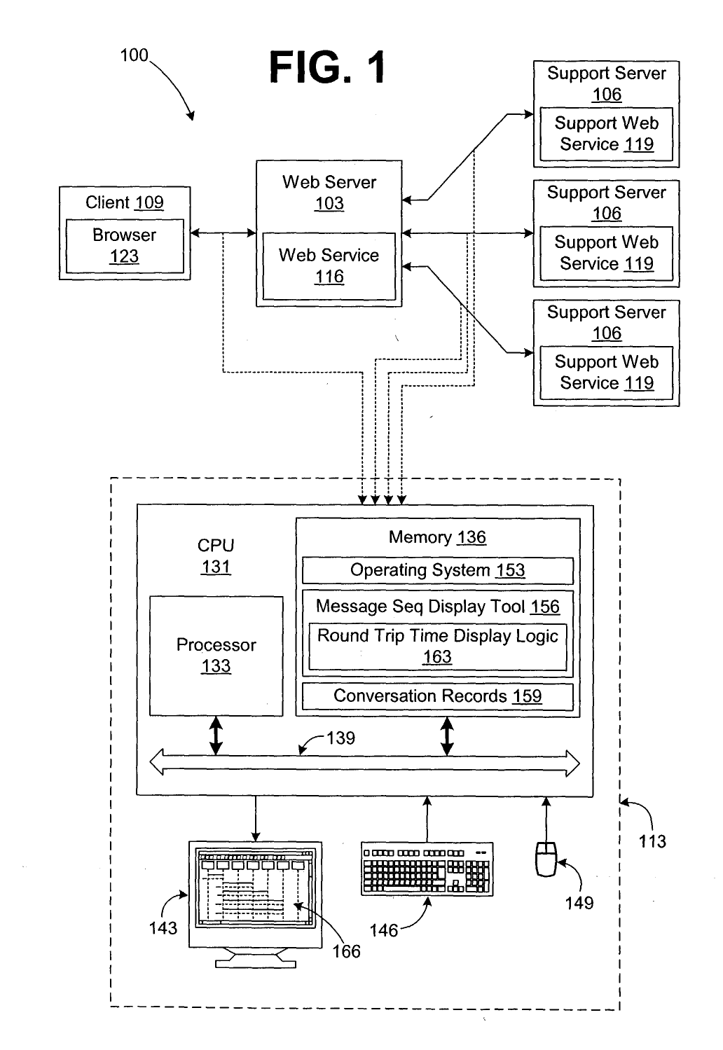

With reference to FIG. 1, shown is a web services network 100 according to an embodiment of the present invention. The web services network 100 includes a web server 103 and a number of support servers 106. The web services network 100 also includes a client 109 in the message monitoring system 113. The client 109, web server 103, support servers 106, and the message monitoring system 113 are all in data communication with each other through an appropriate network such as, for example, the Internet, intranets, wide area networks (WANs), local area networks, wireless networks, or other suitable networks, etc., or any combination of two or more such networks.

A web service 116 is stored and executed within the web server 103. In addition, a support web service 119 is stored and executed within each of the support servers 106. A browser 123 is stored and executed within the client 109 to facilitate interaction with the web service 116. Each of the Web services 116, 119 may comprise other services made available on the Internet beyond specific Web services that are part of the World Wide Web. In addition, all of the support web services 119 may be stored and executed within a single support server 106 or the web server 103. Alternatively, the support web services 119 may be stored and executed in any combination of one or more support servers 106 and the web server 103, etc.

The message monitoring system 113 includes a central processing unit 131 that comprises a processor circuit having a processor 133 and a memory 136, both of which are coupled to a local interface 139. In this respect, the local interface 139 may be, for example, a data bus with an accompanying control/address bus as can be appreciated by those with ordinary skill in the art. The message monitoring system 113 also includes peripheral devices such as, for example, a display device 143, a keyboard 146, in the mouse 149. In addition, the message monitoring system 113 may also include other peripheral devices such as a keypad, touch pad, touch screen, microphone, scanner, joystick, or one or more push buttons, etc. The peripheral devices may also include indicator lights, speakers, printers, etc. The display device 143 may be, for example, a cathode ray tube (CRT), liquid crystal display screen, gas plasma-based flat panel display, or other type of display devices, etc.

The message monitoring system 113 also includes a number of software components stored in the memory 136 that are executable by the processor 133. In this respect, the term “executable” means a program file that is in a form that can be run by the processor 133. Examples of executable programs may be, for example, a compiled program that can be translated into machine code in a format that can be loaded into a random access portion of the memory 136 and run by the processor 133, or source code that may be expressed in proper format such as object code that is capable of being loaded into a of random access portion of the memory 136 and executed by the processor 133, etc.

In one embodiment, the software components that are stored in the memory 136 and are executable by the processor 133 include, for example, an operating system 153, a message sequence display tool 156 and a number of conversation records 159. The message sequence display tool 156 includes round-trip time display logic 163. When executed by the processor 133, the message sequence display tool 156 and the round-trip time display logic 153 generate a user interface 166 on the display device 143.

The memory 136 is defined herein as both volatile and nonvolatile memory and data storage components. Volatile components are those that do not retain data values upon loss of power. Nonvolatile components are those that retain data upon a loss of power. Thus, the memory 136 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 133 may represent multiple processors and the memory 136 may represent multiple memories that operate in parallel. In such a case, the local interface 139 may be an appropriate network that facilitates communication between any two of the multiple processors, between any processor and any one of the memories, or between any two of the memories etc. The processor 133 may be of electrical, optical, or molecular construction, or of some other construction as can be appreciated by those with ordinary skill in the art.

Also, the operating system 153 is executed to control the allocation and usage of hardware resources such as the memory, processing time and peripheral devices in the message monitoring system 113. In this manner, the operating system 153 serves as the foundation on which applications depend as is generally known by those with ordinary skill in the art.

Next, an explanation of the operation of the web services network 100 according to an embodiment of the present invention. The web services network 100 is implemented to test the operation of the web service 116. In this respect, the browser 123 of the client 109 may be manipulated to interact with the web service 116 to implement a transaction that is provided by the web service 116. During the execution of the transaction, a number of round-trip message sequences may be transmitted between the browser 123 in the client 109 and the web service 116 and between the web service 116 and each of the support web services 119. These round-trip message sequences represent the communication between the web service 116 and one or more of the support web services 119 such as, for example, when the web service 116 incorporates data or functionality provided by one or more of the support web services 119 into the response that is sent to the client 109. For example, the operator of the web service 116 may contract with the operators of the support web services 119 to incorporate their content into a web site that is served up to the client 109, etc.

Each of the round-trip message sequences may include, for example, a request message and a response message. Specifically, a request message is transmitted by a requesting one of the devices in the web services network 100 to a second one of the devices, and, an appropriate response message transmitted by the second one of the devices to the original requestor in response to the request message.

A transaction provided by the web service 116 may be implemented multiple times, thereby incurring the same pattern of round-trip message sequences each time. Each of these patterns of round-trip message sequences is recorded and stored as one of the conversation records 159 in the memory 136. Thus, a “conversation” is defined herein as a pattern of round-trip message sequences that occurs during a specific transaction that is implemented by the web service 116. The conversations are stored as conversation records 159. Thus, each of the conversation records 159 comprises a log of each of the round-trip message sequences that take place between any two devices in the web services network 100 during the implementation of the specific transaction.

To record a specific conversation, a user may manipulate the message sequence display tool 156. In this respect, the same transaction may be executed and recorded multiple times, thereby generating multiple instances of the same conversation record. As was stated above, each conversation record 159 includes a log of each request message and the corresponding response message for each round-trip message sequence. Each request message and each response message includes a time stamp that indicates when it was generated and transmitted to the appropriate recipient, etc. Given this information, a round-trip time may be calculated for each of the round-trip message sequences. The round-trip times are useful to developers of the web service 116 as they allow such developers to identify unacceptable delays in the interactions between various devices in the web services network 100 during the execution of the operation of the web service 116.

In addition, given that a number instances of a conversation record 159 can be generated for the same transaction, then a round-trip time may be determined for each round-trip message sequence of the transaction from each instance of the conversation record 159. Thus, a number of round-trip times may be determined for each of the round-trip message sequences and a given transaction. An average round-trip time may then be calculated for each of the round-trip message sequences.

The round-trip time display logic 163 is executed as a portion of the message sequence display tool 156 to display a graphical representation of each of the round-trip message sequences on the display device 143 as a portion of the user interface 166. In addition, the round-trip time display logic 163 displays a respective message sequence time on the display device 143 in association with each of the graphical representations of the round-trip message sequences. In this respect, the message sequence time may be either a round-trip time of the respective round-trip message sequence or an average round-trip time of the round-trip message sequence, assuming that multiple conversation records 159 have been recorded for the respective transaction.

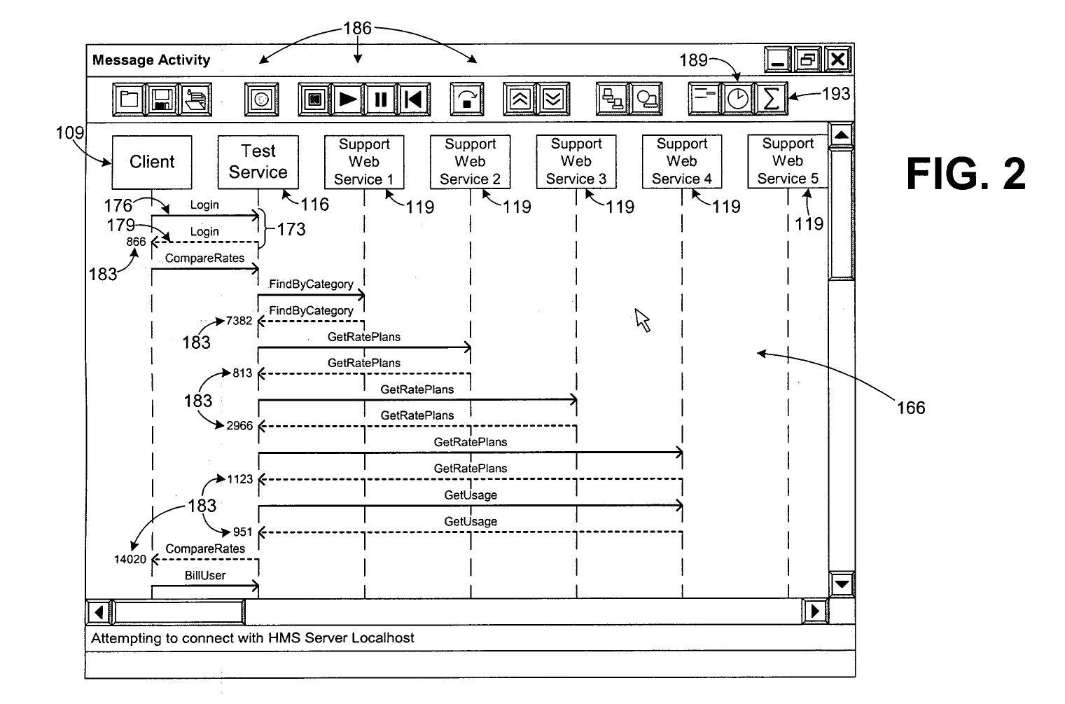

With reference to FIG. 2, shown is an example of the graphical user interface 166 according to an embodiment of the present invention. The user interface 166 displays a graphical representation of each of the round-trip message sequences 173 of a conversation for a specific transaction. In this respect, the conversation may be stored and accessed from a conversation record 159 (FIG. 1) stored in the memory 136 (FIG. 1) or it may be created in real time during the recording of a new conversation between the client 109, web service 116, and the support web services 119.

Each of the graphical representations of the round-trip message sequences 173 includes a graphical representation of both a request message 176 and a response message 179. The user interface 166 also includes a graphical representation of the client 109, the web service 116, and the support web services 119. The round-trip message sequences 173 are represented, for example, as occurring between any two of the client 109, web service 116, and the support web services 119. The request message 176 and response message 179 that make up a specific round-trip message sequence 173 may be separated by other round-trip message sequences 173 as shown.

The user interface 166 also includes a number of message sequence times 183 that are displayed in association with respective graphical representations of the round-trip message sequences 173. Specifically, the message sequence times 183 are displayed in association with the response message 179 of each of the round-trip message sequences 173. This is accomplished, for example, by placing each of the message sequence times 183 in close proximity to a corresponding response message 179. However, it is understood that the associations between the message sequence times 183 and the round-trip message sequences 173 may be indicated in some other manner.

The user interface 166 also includes a number of buttons 186 that may be manipulated by a user to perform such functions as opening conversation records 159, saving conversation records 159, and recording conversations to generate new conversation records 159. In addition, other buttons are provided to facilitate the performance of other functions not discussed herein in detail. According to embodiments of the present invention, among the buttons 186 is a button that acts as a round-trip time display actuator 189 and another one of the buttons is an average toggle actuator 193. While the round-trip time display actuator 189 and the average toggle actuator 193 are depicted as buttons, it is understood that they may be implemented as other types of graphical components.

The round-trip time display actuator 189 and the average toggle actuator 193 are manipulated by a user to display message sequence times 183. In this respect, the round-trip time display actuator 189 includes an actuated state (depressed) and an idle state (released). When the round-trip time display actuator 189 is in the actuated state, message sequence times 183 are displayed in association With their respective round-trip message sequences 173. When the round-trip time display actuator 189 is in the idle state, no message sequence times 183 are displayed.

In addition, the average toggle actuator 193 includes a first state and a second state. When the round-trip time display actuator 189 is in the actuated state and message sequence times 183 are displayed, the average toggle actuator 193 controls whether the message sequence times 183 are round-trip times or averaged round-trip times. If the average toggle actuator 193 is in the first state (released), then the message sequence times 183 displayed by the round-trip time display logic 163 are round-trip times. If the average toggle actuator 193 is in the second state (actuated), then the message sequence times 183 displayed by the round-trip time display logic 163 are average round-trip times. The round-trip time display logic 163 calculates the average round-trip times from all instances of the current displayed conversation record 159 that are available in the memory 136 (FIG. 1). If there are no other conversation records 159 in the memory 136, then the average round-trip times will be equal to the current round-trip times given that a single conversation is available with which to calculate the average round-trip times.

In addition, it is understood that the user interface 166 is merely an example. In this respect, the user interface 166 may be comprised of graphical representations, images, and/or components that differ in appearance from those described in FIG. 2.

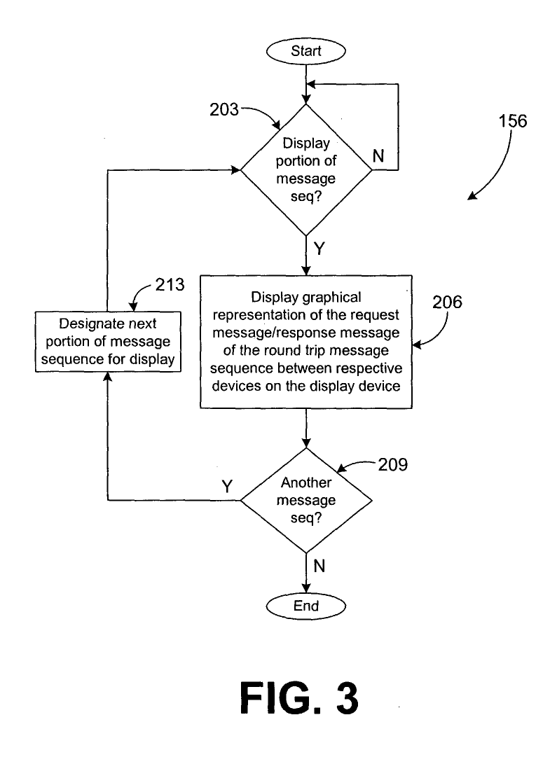

Turning then to FIG. 3, shown is an exemplary flowchart that illustrates a portion of the functionality of the message sequence display tool 156 that generates the graphical representations of the round-trip message sequences 173 (FIG. 2) in the user interface 166 (FIG. 1) according to an embodiment of the present invention. Alternatively, the flowchart of FIG. 3 may be viewed as depicting steps of a method implemented in the message monitoring system 113 for the same. The functionality of the message sequence display tool 156 as depicted by the exemplary flow chart of FIG. 3 may be implemented, for example, in an object oriented design or in some other programming architecture. Assuming the functionality is implemented in an object oriented design, then each block represents functionality that may be implemented in one or more methods that are encapsulated in one or more objects. The message sequence display tool 156 may be implemented using any one of a number of programming languages such as, for example, C, C++, JAVA, Perl, Python, Flash, or other programming languages. It is understood that the message sequence display tool 156 also includes other functionality not discussed herein.

Beginning with box 203, the message sequence display tool 156 determines whether a portion of a round-trip message sequence 173 is to be displayed as a part of the graphical user interface 166 on the display device 143 (FIG. 1). Such a portion may be, for example, a request message 176 (FIG. 2) or a response message 179 (FIG. 2) that are accessed from an appropriate conversation record 159 stored in the memory 136. Note that the conversation record 159 may be a complete conversation record 159 that was previously recorded and stored in the memory 136 or it may be an incomplete conversation record 159 that is currently being recorded during the execution of a specified transaction that involves the web service 116 (FIG. 1).

Assuming that a portion of a round-trip message sequences 173 is to be displayed in box 203, then the message sequence display tool 156 proceeds to box 206 in which the graphical representation of either the request message 176 or response message 179 that make up a round-trip message sequence 173 is generated on the display device 143 as part of the user interface 166. In this respect, ultimately a graphical representation of each round-trip message sequence 173 is generated. Thereafter, in box 209, the message sequence display tool 156 determines whether another portion of a round-trip message sequence 173 is to be displayed on the display device 143 as part of the user interface 166. If such is the case, then the message sequence display tool 156 moves to box 213. Otherwise, the portion of the message sequence display tool 156 that generates the graphical representations of the round-trip display sequences 173 ends. Assuming that the message sequence display tool 156 progresses to box 213, then the next portion of a round-trip message sequence 173 stored in the conversation record 159 is designated for display on the display device 143. Thereafter, the message sequence display tool 156 reverts back to box 203 as shown.

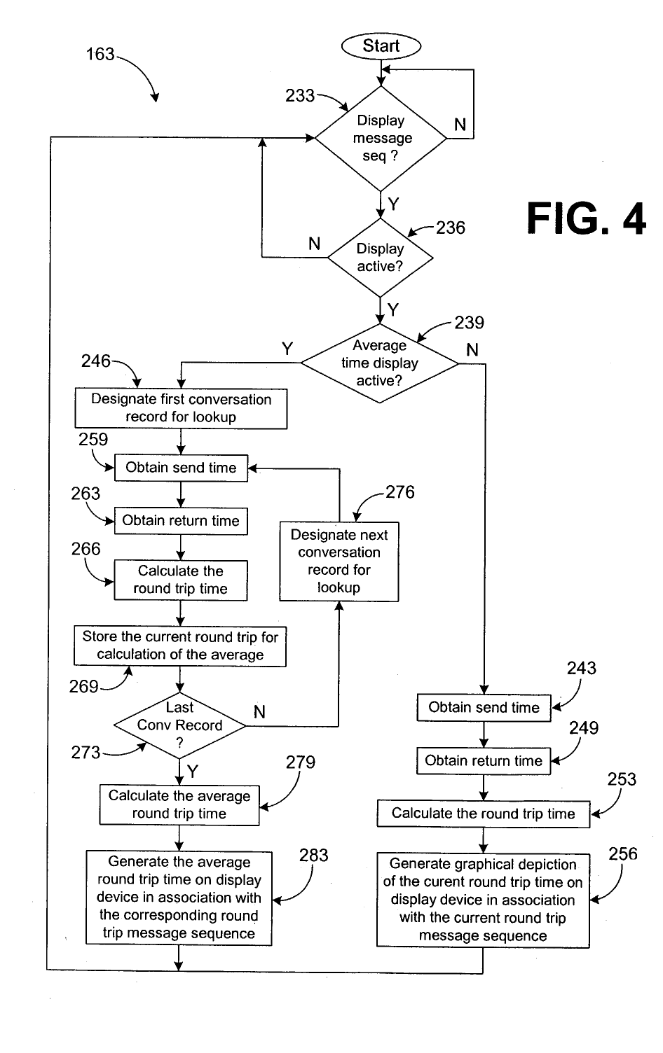

With reference to FIG. 4, shown is a flowchart that provides an example of the round-trip time display logic 163 that is executed to display the message sequence times 183 on the display device 143 (FIG. 1) according to an embodiment of the present invention. Alternatively, the flowchart of FIG. 4 may be viewed as depicting steps of a method implemented in the message monitoring system 113 (FIG. 1) in order to display message sequence times 183 (FIG. 2) according to an embodiment of the present invention. The functionality of the round-trip time display logic 163 as depicted by the exemplary flow chart of FIG. 4 may be implemented, for example, in an object oriented design or in some other programming architecture. Assuming the functionality is implemented in an object oriented design, for example, then each block represents functionality that may be implemented in one or more methods that are encapsulated in one or more objects. In addition, the round-trip time display logic 163 may be implemented using any one of a number of programming languages- such as, for example, C, C++, JAVA, Perl, Python, Flash, or other programming languages.

Beginning with box 233, the round-trip time display logic 163 waits until a new round-trip message sequence 173 (FIG. 2) is displayed on the display device 143 as a portion of the user interface 166 (FIG. 2). This may occur, for example, when both the request message 176 and the response message 179 that make up the respective round-trip message sequence 173 have been displayed on the display device 143. When a new round-trip message sequence 173 has been so displayed, then the round-trip time display logic 163 proceeds to box 236 in which the round-trip time display logic 163 determines whether the message time display actuator 189 (FIG. 2) is in the actuated state, thereby indicating that message sequence times 183 are to be displayed on display device 143. If so, then the round-trip time display logic 163 proceeds to box 239. Otherwise, the round-trip time display logic 163 reverts back to box 233 as shown.

Assuming that the round-trip time display logic 163 has proceeded to box 239, then the state of the average toggle actuator 193 is determined. If the average toggle actuator 193 is in the first state (idle), then the latest round-trip times from the latest conversation record 159 stored in the memory 136 (FIG. 1) are displayed. Alternatively, the round-trip times that are currently being generated by the recording of a conversation may be displayed. If the average toggle actuator 193 is in a second state (i.e. an actuated state), then the message sequence times 183 to be displayed are to be average round-trip times. If the average toggle actuator 193 is in the first state, then the round-trip time display logic 163 proceeds to box 243. If the average toggle actuator 193 is in the second state, then the round-trip time display logic 163 moves to box 246.

Assuming that the round-trip time display logic 163 has proceeded to box 243, then the round-trip time display logic 163 obtains a send time of the request message that is associated with the current round-trip message sequence 173 for which the current message sequence time 183 is to be determined. The send time may be, for example, the time that the request message 176 was generated and transmitting from a sending device or service to a receiving device or service. Thereafter, in box 249, the round-trip display logic 163 obtains a return time of the corresponding response message 179 (FIG. 2) that is associated with the current round-trip message sequence 173 for which the current message sequence time 183 is to be determined. The return time may be, for example, the time that the response message 179 was received by the device or service that generated the original request message 176.

Thereafter, in box 253, the round-trip time display logic 163 calculates the round-trip time. This may be done, for example, by subtracting the send time from the return time or by performing appropriate calculations using other time parameters that may be associated with the request message 176 and the response message 179. Thereafter, in box 256, the round-trip time calculated in box 253 is displayed on the display device 143 as part of the user interface 166. In this respect, the round-trip time is displayed in association with the current round-trip message sequence 173. This may done, for example, by displaying the round-trip time in association with the response message 179 of the current round-trip message sequence 173. The association may be indicated by placing the round-trip time in close proximity to the graphic representation of the request message 176 and/or the response message 179. Alternatively, other approaches may be employed to indicate the association between the round-trip time and the respective message sequence time 173 such as, for example, using color coding, graphical similarity between shapes and, or other approaches. Once the round-trip time display logic 163 has generated the round-trip time on the display device 143, then the round-trip time display logic 163 reverts back to box 233 as shown.

Assuming however that the average toggle actuator 193 is in the second state (actuated) in box 239, then the round-trip time display logic 163 proceeds to box 246 in which a first conversation record 159 (FIG. 1) is identified in the memory 136 to perform a lookup to obtain the appropriate send and return times or other time parameters there from. Thereafter, in box 259, the send time or other appropriate time associated with the request message 176 of the current round-trip message sequence 173 is identified in the current designated conversation record 159. Thereafter, in box 263, the return time of the response message 176 associated with the current round-trip message sequence 173 is identified in the currently designated conversation record 159. Thereafter, in box 266 the round-trip time for the current round-trip message sequence 173 is calculated for the current designated conversation record 159. Thereafter, in box 269, the calculated round-trip time is stored in the memory 136 used in calculating the average round-trip time as will be discussed.

Next, in box 273, the round-trip time display logic 163 determines whether the last conversation record 159 that includes information regarding the current round-trip message sequence 173 (i.e., the last conversation record 159 for the same conversation involving the same transaction) has been consulted to obtain the appropriate send and return times. If not, then the round-trip time display logic 163 proceeds to box 276. Otherwise, the round-trip time display logic 163 proceeds to box 279.

In box 276, the next conversation record 159 that includes information regarding the current round-trip message sequence 173 is designated for lookup of the appropriate send and return times. Thereafter, the round-trip time display logic 163 reverts back to box 259 as shown.

Assuming that the round-trip time display logic 163 proceeds to box 279, then the average round-trip time is calculated from the round-trip times stored in box 269 that were calculated from each one of the respective conversation records 159. Thereafter, in box 283, the average round-trip time is displayed on the display device 143 as part of the user interface 166 in association with the corresponding round-trip message sequence 173. The display of the average round-trip time is implemented in the same manner as was described with regard to the display of the round-trip time in box 256 above. Thereafter, the round-trip time display logic 163 reverts back to box 233 as shown. Thus, in blocks 246 through 279, the round-trip time display logic 163 calculates the average round-trip time based upon a number of occurrences of the respective round-trip message sequence 173 stored in the memory 136 in the respective conversation records 159.

Although the message sequence display tool 156 and, more specifically, the round-trip time display logic 163 are embodied in software or code executed by general purpose hardware as discussed above, as an alternative they may also be embodied in dedicated hardware or a combination of software/general purpose hardware and dedicated hardware. If embodied in dedicated hardware, the message sequence display tool 156 and the round-trip time display logic 163 each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 3-4 show examples of the architecture, functionality, and operation of an implementation of the message sequence display tool 156 and the round-trip time display logic 163. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 3-4 show a specific order of execution, it is understood that the order of execution may differ from that which is depicted. For example, the order of execution of two or more blocks may be scrambled relative to the order shown. Also, two or more blocks shown in succession in FIGS. 3-4 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the message sequence display tool 156 and/or the round-trip time display logic 163 comprise software or code, each can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the message sequence display tool 156 and/or the round-trip time display logic 163 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. A system for displaying message timing, comprising:
a processor circuit having a processor and a memory;
a display device operatively coupled to the processor circuit;
round-trip time display logic stored in the memory and executable by the processor, the round-trip time display logic comprising:
logic that displays a graphical representation of a round-trip message sequence between a first service and a second service on the display device; and
logic that displays a message sequence time of the round-trip message sequence on the display device in association with the graphical representation of the round-trip message sequence.

2. The system of claim 1, wherein the message sequence time further comprises a round-trip time of the round-trip message sequence.

3. The system of claim 1, wherein the message sequence time further comprises an average round-trip time of a number of occurrences of the round-trip message sequence.

4. The system of claim 2, further comprising:
a round-trip time display actuator displayed on the display device, the round-trip time display actuator having an idle state and an actuated state; and
wherein the logic that displays the message sequence time of the round-trip message sequence on the display device in association with the graphical representation of the round-trip message sequence further comprises logic that displays the message sequence time of the round-trip message sequence on the display device in association with the graphical representation of the round-trip message sequence when the round-trip time display actuator is in the actuated state.

5. The system of claim 1, wherein the round-trip time display logic further comprises logic that calculates an average round-trip time based upon a number of occurrences of the round-trip message sequence stored in a memory.

6. The system of claim 1, further comprising:
an average toggle actuator displayed on the display device, the average toggle actuator having a first state and a second state;
wherein the logic that displays the message sequence time of the round-trip message sequence on the display device further comprises:
logic that displays a round-trip time of the round-trip message sequence when the average toggle actuator is in the first state; and
logic that displays an average round-trip time of the round-trip message sequence when the average toggle actuator is in the second state.

7. The system of claim 1, wherein the round-trip message sequence further comprises a request message and a,response message transmitted between the first and second services.

8. The system of claim 7, wherein the logic that displays the graphical representation of the round-trip message sequence between the first service and the second service on the display device further comprises logic that displays a graphical representation of both the request message and the response message.

9. The system of claim 8, wherein the logic that displays the message sequence time of the round-trip message sequence on the display device in association with the graphical representation of the round-trip message sequence further comprises logic that displays the message sequence time in association with the graphical representation of the response message.

10. A program embodied in a computer readable medium for displaying message timing on a display device, comprising:
code that displays a graphical representation of a round-trip message sequence between a first service and a second service on the display device; and
code that displays a message sequence time of the round-trip message sequence on the display device in association with the graphical representation of the round-trip message sequence.

11. The program embodied in the computer readable medium of claim 10, wherein the message sequence time further comprises a round-trip time of the round-trip message sequence.

12. The program embodied in the computer readable medium of claim 10, wherein the message sequence time further comprises an average round-trip time of a number of occurrences of the round-trip message sequence.

13. The program embodied in the computer readable medium of claim 11, further comprising:
code that generates a round-trip time display actuator on the display device, the round-trip time display actuator having an idle state and an actuated state; and
wherein the code that displays the message sequence time of the round-trip message sequence on the display device in association with the graphical representation of the round-trip message sequence further comprises code that displays the message sequence time of the round-trip message sequence on the display device in association with the graphical representation of the round-trip message sequence when the round-trip time display actuator is in the actuated state.

14. The program embodied in the computer readable medium of claim 10, further comprising code that calculates an average round-trip time based upon a number of occurrences of the round-trip message sequence stored in a memory.

15. The program embodied in the computer readable medium of claim 10, further comprising:
code that generates an average toggle actuator on the display device, the average toggle actuator having a first state and a second state;
wherein the code that displays the message sequence time of the round-trip message sequence on the display device further comprises:
code that displays a round-trip time of the round-trip message sequence when the average toggle actuator is in the first state; and
code that displays an average round-trip time of the round-trip message sequence when the average toggle actuator is in the second state.

16. The program embodied in the computer readable medium of claim 10, wherein the round-trip message sequence further comprises a request message and a response message transmitted between the first and second services.

17. The program embodied in the computer readable medium of claim 16, wherein the code that displays the graphical representation of the round-trip message sequence between the first service and the second service on the display device further comprises code that displays a graphical representation of both the request message and the response message.

18. The program embodied in the computer readable medium of claim 17, wherein the code that displays the message sequence time of the round-trip message sequence on the display device in association with the graphical representation of the round-trip message sequence further comprises code that displays the message sequence time in association with the graphical representation of the response message.

19. A method for displaying message timing on a display device, comprising:
displaying a graphical representation of a round-trip message sequence between a first service and a second service on the display device; and
displaying a message sequence time of the round-trip message sequence on the display device in association with the graphical representation of the round-trip message sequence.

20. The method of claim 19, wherein the step of displaying the message sequence time of the round-trip message sequence on the display device further comprises displaying a round-trip time of the round-trip message sequence on the display device.

21. The method of claim 19, wherein the step of displaying the message sequence time of the round-trip message sequence on the display device further comprises displaying an average round-trip time of a number of occurrences of the round-trip message sequence on the display device.

22. The method of claim 20, further comprising the step of:
generating a round-trip time display actuator on the display device, the round-trip time display actuator having an idle state and an actuated state; and
wherein the step of displaying the message sequence time of the round-trip message sequence on the display device in association with the graphical representation of the round-trip message sequence further comprises the step of displaying the message sequence time of the round-trip message sequence on the display device in association with the graphical representation of the round-trip message sequence when the round-trip time display actuator is in the actuated state.

23. The method of claim 19, further comprising the step of:
displaying an average toggle actuator on the display device, the average toggle actuator having a first state and a second state; and
wherein the step of displaying the message sequence time of the round-trip message sequence on the display device further comprises the steps of:
displaying a round-trip time of the round-trip message sequence when the average toggle actuator is in the first state; and
displaying an average round-trip time of the round-trip message sequence when the average toggle actuator is in the second state.

24. A system for displaying message timing, comprising:
means for displaying a graphical representation of a round-trip message sequence between a first service and a second service on a display device; and
means for displaying a message sequence time of the round-trip message sequence on the display device in association with the graphical representation of the round-trip message sequence.

25. The system of claim 24, wherein the message sequence time further comprises a round-trip time of the round-trip message sequence.

26. The system of claim 24, wherein the message sequence time further comprises an average round-trip time of a number of occurrences of the round-trip message sequence.
